(19) United States
(12) Patent Application Publication
(10) Pub. No.: US 2008/0273881 A1
(43) Pub. Date: Nov. 6, 2008

(54) BURST LIGHT RECEIVER, OPTICAL COMMUNICATION SYSTEM, BURST LIGHT RECEPTION CONTROL METHOD AND RECORDING MEDIUM WITH PROGRAM RECORDED THEREIN

(76) Inventor: ATSUSHI FUJIMURA, Tokyo (JP)

Correspondence Address: NEC CORPORATION OF AMERICA, 6535 N. STATE HWY 161, IRVING, TX, 75039, US

(21) Appl. No.: 12/054,574

(22) Filed: Mar. 25, 2008

(30) Foreign Application Priority Data
Mar. 26, 2007 (JP) 2007-079069

(51) Int. Cl. H04B 10/06

(52) U.S. Cl. 398/202

(57) ABSTRACT

To enhance resistance against external factors such as junk data and noise in the burst signal by use of a simple configuration without separately requiring other dedicated circuits such as a mask signal generator, a burst light receiver includes an information restoring unit for receiving a signal from an optical signal receiving unit and extracting therefrom information of a clock signal and data to restore the information and a timing control unit for making the information restoring unit execute burst reset processing at timing of release of a reception interruption signal indicating absence of an optical signal to the optical signal receiving unit.

This application is based upon and claims the benefit of priority from Japanese patent application No. 2007-079069, filed on Mar. 26, 2007, the disclosure of which is incorporated herein in its entirety by reference.

### BACKGROUND OF THE INVENTION

1. Field of the Invention

The present invention relates to a burst light receiver, an optical communication system, a burst light reception control method, and a recording medium with a program recorded thereon in which burst reset processing is executed at reception of burst light.

2. Description of the Related Art

General burst reset processing will be described by referring to FIG. 1.

First, a burst reset processing block conducts a burst reset operation for an optical module (OPT_RESET). After the burst reset operation is carried out, the burst reset processing block performs a burst reset operation for a Clock and Data Recovery or Clock phase Adjust (CDR/CPA) module (CDR_RESET).

When upstream burst data is received (OPT_INDATA), the optical module establishes synchronization according to a leading field, i.e., a preamble of the data and delivers to the CDR/CPA data created by removing the preamble from the upstream burst data (OPT_OUTDATA).

On receiving the upstream burst data from the optical module (OPT_OUTDATA), the CDR/CPA module establishes synchronization according to a preamble of the upstream burst data and outputs data created by removing the preamble from the upstream burst data (CDR_OUTDATA) to an Optical Line Terminal Media Access Control (OLT MAC) unit.

As above, according to a general burst reset processing block, when a burst reset operation for an optical module (OPT_RESET) is conducted, a burst reset operation is conducted for a CDR/CPA module (CDR_RESET).

In this connection, for example, Japanese Patent Laid-Open Pub. Ser. No. 2003-332987 describes an apparatus of the related art associated with to the present invention. According to the apparatus, in the absence of an optical input signal to be fed to an optical module, the optimal module is reset by itself to resultantly produce a Loss Of Signal (LOS) notifying the absence of the optical input signal.

Additionally, for example, Japanese Patent Laid-Open Pub. Ser. No. 2006-254061 describes a device including an output controller which produces, while a mask signal is being received, a signal of an appropriate non-signal level in place of an ordinary output signal and a mask signal generator which produces a mask signal during a non-signal period of a burst light signal or during a period of time up to when an output signal is stabilized. In the configuration, the device stops outputting the mask signal when a predetermined period of time lapses after the burst light signal is received.

The general burst reset processing according to the above related art is accompanied by problems as follows.

First, since the burst reset processing block carries out the burst reset operation for the CDR/CPA unit (CDR_RESET) after recognizing that the burst reset operation has been conducted for the optical module (OPT_RESET), signals of junk data and noise generated during these burst reset operations are disadvantageously taken in the receiver.

Second, due to the same reason for the first problem, if a phase shift occurs in the upstream burst data, it is not likely that the burst reset operation is accomplished at an appropriate timing.

Also, according to the technique of Japanese Patent Laid-Open Pub. Ser. No. 2003-332987, the reset is triggered when no optical input signal is present and the device to be reset is the optical module itself. In this regard, consideration has not been given to improvement in strength or resistance of the apparatus against external factors such as junk data and noise in the burst signal.

Also, according to the technique of Japanese Patent Laid-Open Pub. Ser. No. 2006-254061, to remove influences from external factors such as junk data and noise during the non-signal period of the burst light signal and during the period of time up to when an output signal is stabilized, there are additionally required a circuit to generate a mask signal and an output control circuit to change an output signal therefrom according to the mask signal.

### SUMMARY OF THE INVENTION

It is therefore an exemplary object of the present invention aiming to solve the above problems to provide a burst light receiver, an optical communication system, a burst light reception control method, and a recording medium with a program recorded therein in which resistance against external factors such as junk data and noise occurring in the burst signal is improved using a simple configuration and without requiring or adopting dedicated circuits such as a mask signal generator.

To achieve the exemplary object in accordance with the present invention, there is provided a burst light receiver including an optical signal receiving unit for receiving an optical signal, an information restoring unit for receiving a signal inputted from the optical signal receiving unit, extracting therefrom information of a clock signal and data, and restoring the information; and a timing control unit for making the information restoring unit execute burst reset processing at timing when a reception interruption signal indicating absence of an optical signal to be inputted to the optical signal receiving unit is released.

There is also provided an optical communication system, wherein the burst light receiver is connected via an optical splitter to a plurality of optical communication apparatuses.

In accordance with the present invention, there is provided a burst light reception control method, including a step of making, at timing when a reception interruption signal indicating absence of an optical signal to be inputted to an optical signal receiving unit receiving an optical signal is released, an information restoring unit extracting information of a clock signal and data from the signal and restoring the information execute burst reset processing.

There is also provided in accordance with the present invention a recording medium having stored a burst light reception control program for making a computer execute processing for making, at timing when a reception interruption signal indicating absence of an optical signal to be inputted to an optical signal receiving unit receiving an optical signal is released, an information restoring unit extracting information of a clock signal and data from the signal and restoring the information execute burst reset processing.

### BRIEF DESCRIPTION OF THE DRAWINGS

The exemplary objects and features of the present invention will become more apparent from the consideration of the following detailed description taken in conjunction with the accompanying drawings in which:

FIG. 1 is a signal timing chart showing in detail burst reset processing in a Passive Optical Network (PON) system according to a related art of the present invention;

FIG. 2 is a block diagram showing a main section of an OLT in an exemplary embodiment of the present invention;

FIG. 3 is a schematic diagram showing an outline of structure of an exemplary embodiment of a PON system in accordance with the present invention;

FIG. 4 is a signal timing chart showing a relationship between a downstream signal BWmap from an OLT 1 and upstream burst data from an Optical Network Unit (ONU);

FIG. 5 is a signal timing chart showing an example of operation when an optical communication line is in an operative state in the exemplary embodiment of a PON system;

FIG. 6 is a signal timing chart showing an example of operation when an optical communication line is not in an operative state in the exemplary embodiment of a PON system; and

FIG. 7 is a signal timing chart showing in detail burst reset processing in the PON system.

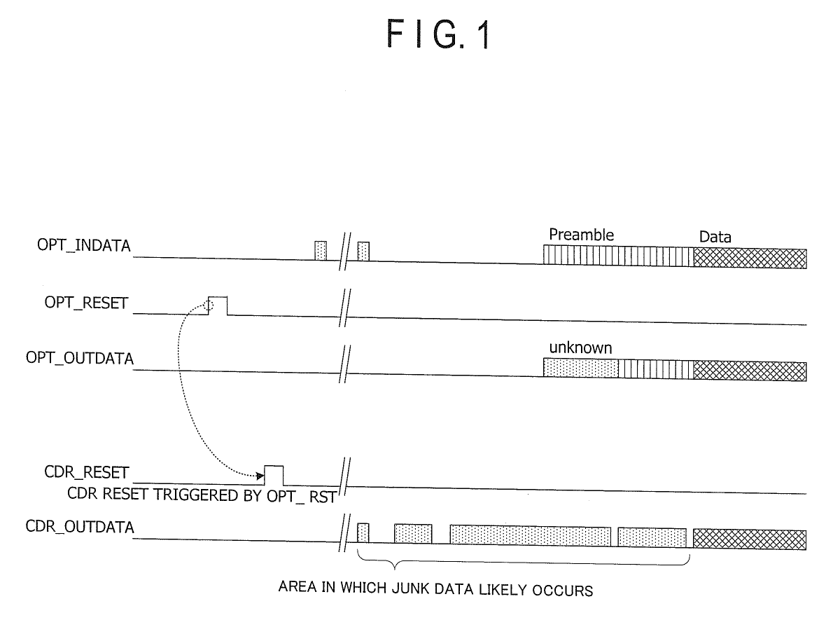

### DESCRIPTION OF THE EMBODIMENTS

Referring next to the drawings, description will be given in detail of an exemplary embodiment of a PON system employing a burst light receiver, an optical communication system, a burst light reception control method, and a recording medium with a program recorded therein in accordance with the present invention.

Description will be given of an outline of the exemplary embodiment.

According to the exemplary embodiment of a PON system, the upstream burst processing is executed such that the burst reset processing for a CDR or CPA unit dynamically follows an LOS signal of the optical module to thereby improve strength against external factors such as junk data and noise occurring in the upstream burst signal. In this regard, the burst reset processing is processing to initiate, before receiving a burst signal from a communication party on a receiving side, processing associated with the receiving processing.

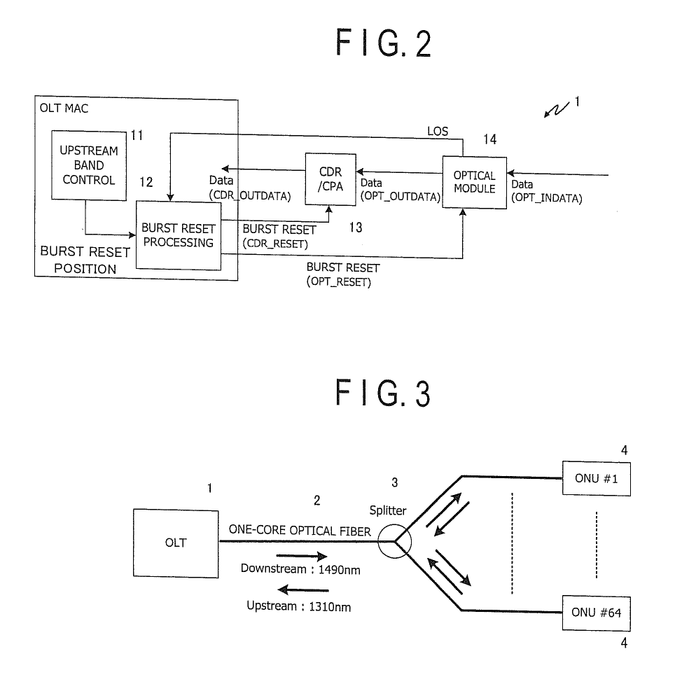

Referring now to FIG. 2, an upstream band control block (a band control unit) 11 notifies a burst reset position to a burst reset processing block (a timing control unit) 12. The burst reset processing block 12 sends a burst reset signal to an optical module (an optical signal receiving unit) 14.

In the absence of an optical input signal, the optical module 14 transmits an LOS signal (a reception interruption signal) indicating the condition to the burst reset processing block 12. On recognizing that the LOS signal has been released, the burst reset processing block 12 sends a burst reset signal to the CDR/CPA unit (an information restoring unit) 13.

Since the reset processing for the upstream burst data is associated with the LOS signal in the exemplary embodiment, it is possible to increase strength or resistance against external factors such as junk data and noise occurring in the upstream burst data.

In more detail, according to the dynamic burst reset scheme in the exemplary embodiment of a PON system, since the reset processing for the upstream burst data is executed in association with the LOS signal, it is prevented that signals of junk data and noise occurring during a period of time from the burst reset for the optical module 14 to the burst reset for the CDR/CPA unit 13 are taken in the receiver. This consequently enhances the resistance against external factors such as junk data and noise occurring in the upstream burst data.

Referring next to FIG. 3, description will be given in detail of structure of an exemplary embodiment of a General PON (GPON) system in accordance with the present invention.

As FIG. 3 shows, in the GPON system, a splitter (an optical splitter) 3 receives a downstream signal sent from an OLT (a terminal equipment on the station side) 1 and splits the signal and delivers a resultant signal to each ONU (a terminal equipment on the subscriber side) 4. The splitter 3 also multiplexes an upstream signal from each ONU 4 as a communication party to send a resultant signal to the OLT 1 as a burst light receiver. The configuration also includes an optical fiber 2 which works as a signal transmission line or path.

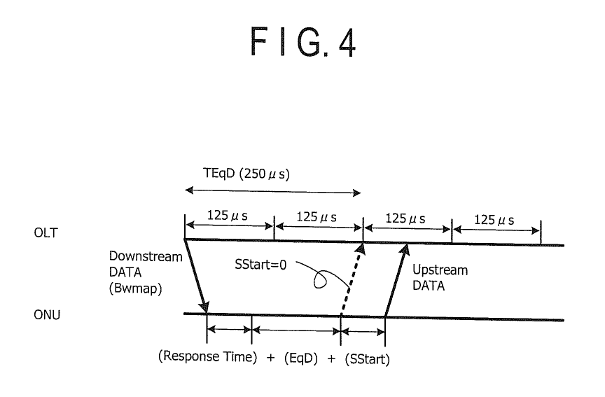

FIG. 4 shows in detail timing of a downstream signal (BWmap) from the OLT 1 of FIG. 3 and arrival timing of upstream burst data from the ONU 4 to the OLT 1.

To receive the upstream burst data at timing of TEqD (250 microseconds), the OLT 1 measures in a ranging procedure an Equalization Delay (EqD) indicating a transmission delay of the upstream burst data according to distance to each ONU 4 and then notifies the value of EqD to each ONU 4. The OLT 1 informs the ONU 4 of band allocation information (BWmap) at an interval of 125 microseconds.

The OLT 1 notifies transmission timing of the upstream burst data of each ONU 4 using band allocation information (BWmap) in the downstream data. After the reception of Bwmap, the ONU 4 waits for the time including a response time (Response Time) of the ONU 4, a time of transmission delay (EqD), and a transmission start timing period (SStart) on the basis of the Bwmap form the OLT 1 to elapse, and transmits the upstream burst data.

The OLT 1 receives the upstream burst data from the ONU 4 to which a band allocated by the BWmap, during a 125 microseconds window at timing when a period of time of TEqD (250 microseconds) lapses after the downstream signal (Bwmap) is transmitted.

Description has been given in detail of the configuration of the exemplary embodiment. However, the definition of Response Time, the EqD calculation method, and the definition of SStart have been well known to those skilled in the art and are not directly associated with the present invention, and hence description thereof will be avoided.

Next, description will be given of operation of the exemplary embodiment of the PON system.

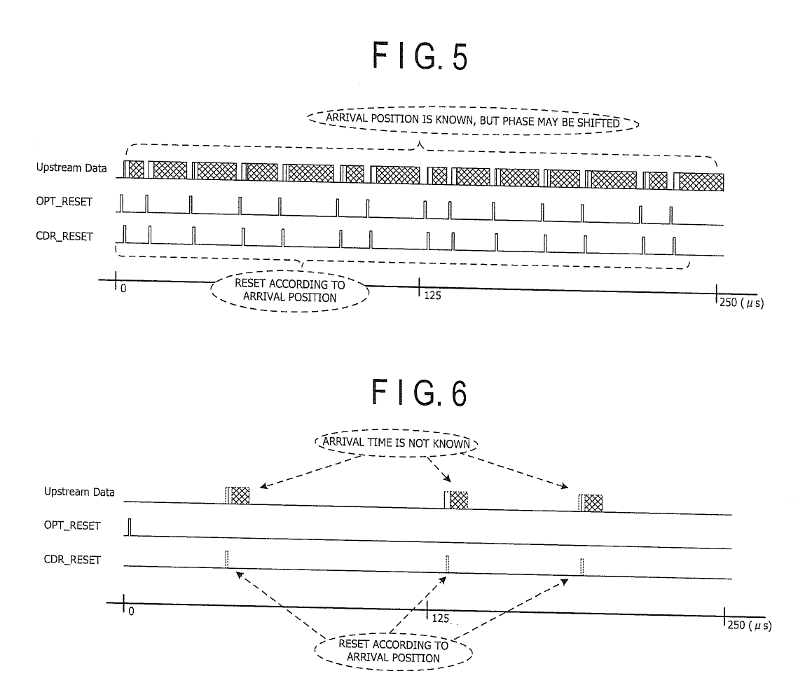

Referring now to FIG. 5, description will be given of the operation when the optical communication line is in an operative state. FIG. 5 shows timing of signals in the operative state, specifically, timing to reset the burst data to the optical module 14 and timing to reset the burst data to the CDR/CPA unit 13 in association with arrival timing when the upstream burst data shown in FIG. 4 arrives at the OLT 1.

According to beforehand-stored arrival timing of arrival of the upstream burst data at the OLT 1, the upstream band control block 11 of the OLT 1 instructs the burst reset processing block 12 to transmit a burst reset signal (OPT_RESET) to the optical module 14 to thereby conduct the burst reset operation.

In the OLT 1, the burst reset processing block 12 sends a burst reset signal (CDR_RESET) to the CDR/CPA unit 13 when an LOS signal is released, to resultantly carry out the burst reset operation. Therefore, the burst reset operation is accomplished for the CDR/CPA unit 13 in association with a shift in the arrival phase of the upstream burst data.

Referring to FIG. 6, description will be given of the operation when the optical communication line is in a non-operative state, e.g., in a ranging state. FIG. 6 shows burst reset timing for the optical module 14 and for the CDR/CPA unit 13 in the non-operative state.

Arrival timing when the upstream burst data arrives at the OLT 1 is unknown to the OLT 1. Therefore, when the OLT 1 starts waiting for upstream burst data from the ONU 4, the OLT 1 simultaneously drives the burst reset processing block 12 to transmit a burst reset signal OPT_RESET to the optical module 14 to thereby accomplish the burst reset operation.

To conduct the burst reset operation in the OLT 1, the burst reset processing block 12 transmits a burst reset signal CDR_RESET to the CDR/CPA unit 13 when an LOS signal is released. As a result, the burst reset operation is carried out for the CDR/CPA unit 13 in association with an arrival position of the upstream burst data.

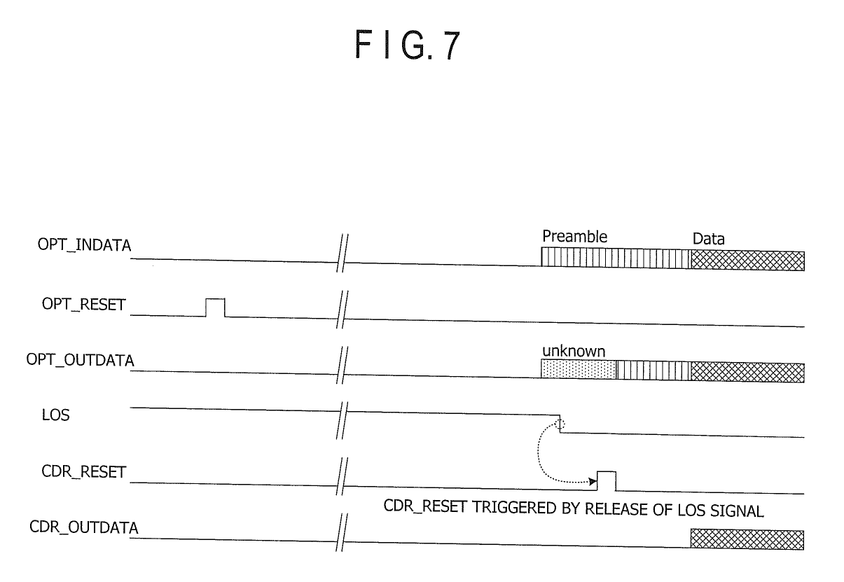

Referring now to the signal timing chart of FIG. 7, description will be given of the burst reset processing shown in FIGS. 5 and 6. The signal names and the function names used in FIG. 2 are also employed in FIG. 7.

The burst reset processing block 12 transmits a burst reset signal OPT_RESET to the optical module 14 to carry out the burst reset operation. When the upstream burst data OPT_INDATA is inputted, the optical module 14 establishes synchronization using a preamble of the upstream burst data.

The optical module 14 removes the preamble from the upstream burst data to send the resultant data OPT_OUTDATA to the CDR/CPA unit 13. At detection of the input of the data OPT_INDATA, the optical module 14 notifies release of the LOS signal to the burst reset processing block 12.

In association with the LOS signal release, the burst reset processing block 12 transmits a burst reset signal CDR_RESET to the CDR/CPA unit 13.

At reception of the data OPT_OUTDATA from the optical module 14, the CDR/CPA unit 13 establishes synchronization using a preamble of the upstream burst data. The CDR/CPA unit 13 removes the preamble from the upstream burst data and transmits the resultant data CDR_OUTDATA to the OLT MAC unit.

In accordance with the exemplary embodiment, there are obtained advantages as follows.

First, since the burst reset processing block 12 conducts the reset operation of the burst data in association with the LOS signal, signals of junk data and noise occurring between the burst reset for the optical module 14 and the burst reset for the CDR/CPA unit 13 are not taken in the receiver.

Second, since the burst reset processing block 12 conducts the reset operation of the burst data in association with the LOS signal, the burst reset is accomplished at appropriate timing even if there appears a shift in the phase of the upstream burst data.

According to the exemplary embodiment, at timing of release of the LOS signal produced from the optical module 14, the burst reset processing is executed for the CDR/CPA unit 13 receiving signals from the optical module 14. Hence, even if there is employed an optical module from which signals of junk data and noise are not completely masked, resistance against external factors such as junk data and noise occurring in the burst signal is improved by using a simple configuration and without utilizing dedicated circuits such as a mask signal generating circuit. Therefore, it is possible to suppress erroneous operations in the CDR/CPA unit 13.

While the invention has been particularly shown and described with reference to an exemplary embodiment thereof, the invention is not limited to the exemplary embodiment. It will be understood by those of ordinary skill in the art that various changes in form and details may be made therein without departing from the spirit and scope of the present invention as defined claims.

For example, the optical module 14 may be constructed using an electric module capable of receiving burst signals.

The OLT MAC unit may be configured using a functional block, which is other than those of the PON system which is requiring the burst reception.

It is also possible that a program to realize a processing procedure performing each of the exemplary embodiments of the PON system in accordance with the present invention is stored in a recording medium such that the program is read from the medium to be executed by a CPU of a computer in the system to resultantly accomplish the functions of the exemplary embodiments.

The present invention is applicable also when information including the program is read from the recording medium or is supplied via a network from an external recording medium to an output device.

That is, the program code attained from the recording medium materializes the novel function of the present invention. That is, the present invention also includes the recording medium storing the program code as well as signals read from the medium.

The recoding medium may be, for example, a flexible disk, a hard disk, an optical disk, a magneto-optical disk, a Compact Disk Read Only Memory (CD-ROM), a CD-R, a CD-RW, a Digital Versatile Disk ROM (DVD-ROM), DVD Random Access Memory (DVD-RAM), DVD-RW, DVD+RW, a magnetic tape, a nonvolatile memory card, or an ROM.

By use of the recording medium storing the program in accordance with the present invention, it is possible to implement the respective functions of the exemplary embodiments of the PON system in accordance with the present invention.

As described above, there is provided in accordance with the present invention, a burst light receiver including an optical signal receiving unit for receiving an optical signal, an information restoring unit for receiving a signal inputted from the optical signal receiving unit, extracting therefrom information of a clock signal and data, and restoring the information; and a timing control unit for making the information restoring unit execute burst reset processing at timing when a reception interruption signal indicating absence of an optical signal to be inputted to the optical signal receiving unit is released.

It is favorable that the timing control unit makes, after making the optical signal receiving unit execute burst reset processing, the information restoring unit execute burst reset processing at timing when the reception interruption signal outputted from the optical signal receiving unit is released by the optical signal receiving unit.

Desirably, the burst light receiver further includes a band control unit for controlling a band in an operative state, and the timing control unit makes, if an optical communication line is in an operative state, the optical signal receiving unit execute burst reset processing according to an indication of timing from the band control unit.

In accordance with the present invention, there is provided an optical communication system wherein the burst light receiver is connected via an optical splitter to a plurality of optical communication apparatuses.

There is provided in accordance with the present invention a burst light reception control method including a step of making, at timing when a reception interruption signal indicating absence of an optical signal to be inputted to an optical signal receiving unit receiving an optical signal is released, an information restoring unit extracting information of a clock signal and data from the signal and restoring the information execute burst reset processing.

It is desirable that the burst light reception control method further includes a step of making, after making the optical signal receiving unit execute burst reset processing, the information restoring unit execute burst reset processing at timing when the reception interruption signal outputted from the optical signal receiving unit is released by the optical signal receiving unit.

Favorably, the burst light reception control method further includes a step of making, if an optical communication line is in an operative state, the optical signal receiving unit execute burst reset processing according to an indication of timing from band control unit controlling a band in an operative state.

In accordance with the present invention, there is provided a recording medium having stored a burst light reception control program for making a computer execute processing for making, at timing when a reception interruption signal indicating absence of an optical signal to be inputted to an optical signal receiving unit receiving an optical signal is released, an information restoring unit extracting information of a clock signal and data from the signal and restoring the information execute burst reset processing.

Desirably, the recording medium having stored a burst light reception control program further making a computer execute processing for making, after making the optical signal receiving unit execute burst reset processing, the information restoring unit execute burst reset processing at timing when the reception interruption signal outputted from the optical signal receiving unit is released by the optical signal receiving unit.

It is favorable that the recording medium having stored a burst light reception control program further makes a computer execute processing for making, if an optical communication line is in an operative state, the optical signal receiving unit execute burst reset processing according to an indication of timing from band control unit controlling a band in an operative state.

In accordance with the present invention, it is possible to enhance resistance against external factors such as junk data and noise appearing in the burst signal by use of a simple configuration without separately requiring other dedicated circuits such as a mask signal generator.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A burst light receiver, comprising:
an optical signal receiving unit for receiving an optical signal;
an information restoring unit for receiving a signal inputted from the optical signal receiving unit, extracting therefrom information of a clock signal and data, and restoring the information; and
a timing control unit for making the information restoring means execute burst reset processing at timing when a reception interruption signal indicating absence of an optical signal to be inputted to the optical signal receiving unit is released.

2. The burst light receiver in accordance with claim 1, wherein the timing control unit makes, after making the optical signal receiving unit execute burst reset processing, the information restoring unit execute burst reset processing at timing when the reception interruption signal outputted from the optical signal receiving unit is released by the optical signal receiving unit.

3. The burst light receiver in accordance with claim 2, further comprising a band control unit for controlling a band in an operative state, wherein
the timing control unit makes, if an optical communication line is in an operative state, the optical signal receiving unit execute burst reset processing according to an indication of timing from the band control unit.

4. A burst light receiver, comprising:
an optical signal receiving means for receiving an optical signal;
an information restoring means for receiving a signal inputted from the optical signal receiving means, extracting therefrom information of a clock signal and data, and restoring the information; and
a timing control means for making the information restoring means execute burst reset processing at timing when a reception interruption signal indicating absence of an optical signal to be inputted to the optical signal receiving means is released.

5. An optical communication system, wherein the burst light receiver in accordance with claim 1 is connected via an optical splitting unit to a plurality of optical communication apparatuses.

6. A burst light reception control method, comprising a step of making, at timing when a reception interruption signal indicating absence of an optical signal to be inputted to an optical signal receiving means receiving an optical signal is released, an information restoring means extracting information of a clock signal and data from the signal and restoring the information execute burst reset processing.

7. The burst light reception control method in accordance with claim 6, further comprising a step of making, after making the optical signal receiving means execute burst reset processing, the information restoring means execute burst reset processing at timing when the reception interruption signal outputted from the optical signal receiving means is released by the optical signal receiving means.

8. The burst light reception control method in accordance with claim 7, further comprising a step of making, if an optical communication line is in an operative state, the optical signal receiving means execute burst reset processing according to an indication of timing from band control means controlling a band in an operative state.

9. A recording medium having stored a burst light reception control program for making a computer execute processing for making, at timing when a reception interruption signal indicating absence of an optical signal to be inputted to an optical signal receiving means receiving an optical signal is released, an information restoring means extracting information of a clock signal and data from the signal and restoring the information execute burst reset processing.

10. The recording medium having stored a burst light reception control program in accordance with claim 9, further making a computer execute processing for making, after making the optical signal receiving means execute burst reset processing, the information restoring means execute burst reset processing at timing when the reception interruption signal outputted from the optical signal receiving means is released by the optical signal receiving means.

11. The recording medium having stored a burst light reception control program in accordance with claim 10, further making a computer execute processing for making, if an optical communication line is in an operative state, the optical signal receiving means execute burst reset processing according to an indication of timing from band control means controlling a band in an operative state.
